(19) United States
(12) Patent Application Publication
(10) Pub. No.: US 2011/0097629 A1
(43) Pub. Date: Apr. 28, 2011

(54) Negative Active Material for Rechargeable Lithium Battery and Rechargeable Lithium Battery Including Same

(75) Inventors: Kyoung-Han Yew, Yongin-si (KR); Young-Min KIM, Yongin-si (KR); Sang-Min LEE, Yongin-si (KR); Goo-Jin JEONG, Yongin-si (KR); Young-Hwan KIM, Yongin-si (KR)

(73) Assignee: Samsung SDI Co., Ltd., Yongin-si (KR)

(21) Appl. No.: 12/854,623

(22) Filed: Aug. 11, 2010

(30) Foreign Application Priority Data
Oct. 28, 2009 (KR) 10-2009-0102908

(51) Int. Cl. H01M 4/583

(52) U.S. Cl. 429/231.8

(57) ABSTRACT

A negative active material for a rechargeable lithium battery and a rechargeable lithium battery including the same. The negative active material includes Si-based material core, a carbon coating layer coating the surface of the Si-based material core, and an inorganic salt position on the surface of the carbon coating layer.

### CLAIM OF PRIORITY

This application claims priority to and the benefit of Korean Patent Application No. 10-2009-0102908 filed in the Korean Intellectual Property Office on Oct. 28, 2009, the entire contents of which are incorporated herein by reference.

### BACKGROUND OF THE INVENTION

1. Field of the Invention

The general inventive concept relates to a negative active material for a rechargeable lithium battery and a rechargeable lithium battery including the same.

2. Description of the Related Art

Lithium rechargeable batteries have recently drawn attention as a power source of small portable electronic devices. They use an organic electrolyte solution and thereby have twice the discharge voltage of a conventional battery using an alkali aqueous solution, and accordingly have high energy density.

The above information disclosed in this Related Art section is only for enhancement of understanding of the background of the invention and therefore it may contain information that does not form the prior art that is already known to a person of ordinary skill in the art.

### SUMMARY OF THE INVENTION

One aspect of this disclosure provides a negative active material for a rechargeable lithium battery have an improved cycle life characteristic.

Another aspect of this disclosure provides a rechargeable lithium battery including the negative active material.

According to one aspect of this disclosure, a negative active material for a rechargeable lithium battery is provided that includes a Si-based material core, a carbon coating layer coating the surface of the Si-based material core, and an inorganic salt position on the surface of the carbon coating layer.

The Si-based material core includes Si, SiOₓ (0<x<2), a Si—Z alloy (where Z is an element selected from the group consisting of an alkali metal, an alkaline-earth metal, a group 13 element, a group 14 element, a transition element, a rare earth element, and a combination thereof, and not Si), or a combination thereof.

The carbon coating layer may include an amorphous carbon. The carbon coating layer may include an amorphous carbon selected from the group consisting of soft carbon (low-temperature fired carbon), hard carbon, mesophase pitch carbide, fired coke and a mixture thereof. The content of the carbon coating layer may range from about 1 part by weight to about 20 parts by weight based on 100 parts by weight of the entire active material. The thickness of the carbon coating layer may range from about 1 nm to about 100 nm.

The inorganic salt may be selected from the group consisting of a salt of alkali cation and carbonate anion, a salt of alkali cation and halogen anion, and a combination thereof. The inorganic salt may be selected from the group consisting of Li₂CO₃, Na₂CO₃, K₂CO₃, LiF, KF, LiCl, NaCl, KCl and a combination thereof. The inorganic salt may be selected from the group consisting of Li₂CO₃, LiF, KCl and a combination thereof. The content of the inorganic salt may range from about 0.1 part by weight to about 10 parts by weight based on 100 parts by weight of the entire active material. The inorganic salt may exist in the form in of a layer covering the entire surface of the carbon coating layer, or in the form of islands covering at least a portion of the surface of the carbon coating layer.

Also, according to yet another aspect of this disclosure, a rechargeable lithium battery is provided that includes a negative electrode having the negative active material, a positive electrode having a positive active material, and a non-aqueous electrolyte.

One embodiment of this disclosure provides a negative active material for a rechargeable lithium battery having an excellent cycle life characteristic.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 shows a negative active material according to one embodiment of this disclosure.

FIG. 2 is a schematic view of a rechargeable lithium battery according to one embodiment.

FIG. 3 is a graph showing resistances of rechargeable lithium battery cells manufactured according to Examples 5 and 6 and Comparative Example 1.

### DETAILED DESCRIPTION OF THE INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the principles for the present invention.

Recognizing that sizes and thicknesses of constituent members shown in the accompanying drawings are arbitrarily given for better understanding and ease of description, the present invention is not limited to the illustrated sizes and thicknesses.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. Alternatively, when an element is referred to as being “directly on” another element, there are no intervening elements present.

In order to clarify the present invention, elements extrinsic to the description are omitted from the details of this description, and like reference numerals refer to like elements throughout the specification.

In several exemplary embodiments, constituent elements having the same configuration are representatively described in a first exemplary embodiment by using the same reference numeral and only constituent elements other than the constituent elements described in the first exemplary embodiment will be described in other embodiments.

In a conventional rechargeable lithium battery positive active materials are used. For positive active materials of a rechargeable lithium battery, lithium-transition element composite oxides being capable of intercalating lithium such as LiCoO₂, LiMn₂O₄, LiNi₁₋ₓ, CoₓO₂ (0<x<1), and so on have been researched.

As for negative active materials of a conventional rechargeable lithium battery, various carbon-based materials such as artificial graphite, natural graphite, and hard carbon, which can all intercalate and deintercalate lithium ions, have been used. Graphite of the carbon-based material increases discharge voltage and energy density of a battery because it has a low discharge potential of −0.2V, compared to lithium. A battery using graphite as a negative active material has a high average discharge potential of 3.6V and excellent energy density. Furthermore, graphite is most comprehensively used among the aforementioned carbon-based materials since graphite guarantees better cycle life for a battery due to its outstanding reversibility. However, a graphite active material has low density (theoretical density of 2.2 g/cc) and consequently low capacity in terms of energy density per unit volume when using the graphite as a negative active material. Furthermore, it involves swelling or capacity reduction when a battery is misused or overcharged and the like, because graphite is likely to react with an organic electrolyte at a high discharge voltage.

In order to solve these problems, a great deal of research on non-carbon-based negative active materials has recently been performed. However, such an oxide negative electrode does not show a sufficient improved battery performance and therefore there has been a great deal of further research into oxide negative materials.

The negative active material for a rechargeable lithium battery according to one embodiment includes a Si-based material core, a carbon coating layer coating the surface of the Si-based material core, and an inorganic salt position on the surface of the carbon coating layer.

The negative active material includes a Si-based material as a core. The Si-based material includes Si, SiOₓ (0<x<2), a Si—Z alloy (where Z is an element selected from the group consisting of an alkali metal, an alkaline-earth metal, a group 13 element, a group 14 element, a transition element, a rare earth element, and a combination thereof, and not Si), or a combination thereof. The element Z is selected from the group consisting of Mg, Ca, Sr, Ba, Ra, Sc, Y, La, Ti, Zr, Hf, V, Nb, Ta, Cr, Mo, W, Tc, Re, Fe, Ru, Os, Co, Rh, Ir, Ni, Pd, Pt, Cu, Ag, Au, Zn, Cd, B, Ge, P, As, Sb, Bi, S, Se, Te, Po, and a combination thereof.

The surface of the core formed of the Si-based material may be coated with a carbon coating layer. The carbon coating layer may include an amorphous carbon. The amorphous carbon may be at least one selected from the group consisting of soft carbon (low-temperature fired carbon), hard carbon, mesophase pitch carbide, fired coke, and a mixture thereof.

The amorphous carbon may be included in a content ranging from about 1 part by weight to about 20 parts by weight based on the total weight of the negative active material. When the content of the amorphous carbon falls in the range, the rechargeable lithium battery including the negative active material may form a wide conduction network and maintain a conduction path between active materials having a relatively low conductivity. Thus, it is advantageous in that the electric conductivity of the rechargeable lithium battery may be improved.

The carbon coating layer may have a thickness ranging from about 1 nm to about 100 nm. When the carbon coating layer is excessively thin, the rechargeable lithium battery does not have sufficient conduction path. When the carbon coating layer is excessively thick, the battery capacity may be deteriorated. When the thickness of the carbon coating layer is within the range, the electric conductivity of the rechargeable lithium battery including the negative active material may be improved.

The carbon coating layer may be formed by coating a core formed of a Si-based material with an amorphous carbon. The amorphous carbon may be selected from the group consisting of soft carbon (low-temperature fired carbon), hard carbon, mesophase pitch carbide, fired coke and a combination thereof. The coating method for the carbon coating layer is not limited to it and a dry coating or a liquid coating may be used. Examples of the dry coating method include a deposition method and a chemical vapor deposition (CVD) method, and examples of the liquid coating include an impregnation method and a spray method. When the liquid coating is used, DMSO or THF may be used as a solvent, and the concentration of carbon material in the solvent may range from about 1 wt % to about 20 wt %.

Also, the carbon coating layer may be formed by coating a core formed of a Si-based material with a carbon precursor and heating it in the atmosphere of an inert gas such as argon or nitrogen at a temperature of about 400° C. to about 1200° C. for about 1 hour to about 10 hours. While the heat treatment is performed, the carbon precursor is carbonized and transformed into amorphous carbon, and thus an amorphous carbon coating layer is formed on the surface of the core. Non-limiting examples of the carbon precursor include coal pitch, mesophase pitch, petroleum pitch, coal oil, petroleum heavy oil, and polymer resin such as phenol resin, furan resin, and polyimide resin but the carbon precursor is not limited to them. In particular, a vinyl-based resin such as polyvinylidene fluoride (PVDF), polyvinylchloride (PVC), and the like, a conductive polymer such as polyaniline (PAn), polyacetylene, polypyrrole, polythiophene, and the like may be used, and the conductive polymer may be doped with hydrochloric acid.

Subsequently, an inorganic salt may be disposed on the surface of the carbon coating layer coated with the Si-based material. The inorganic salt may be selected from the group consisting of a salt of alkali metal cation and carbonate anion, a salt of alkali cation and halogen anion and a combination thereof. The inorganic salt may be selected from the group consisting of Li₂CO₃, Na₂CO₃, K₂CO₃, LiF, LiCl, NaCl, KCl, and a combination thereof. In one embodiment, the inorganic salt selected from the group consisting of Na₂CO₃, K₂CO₃, KF, NaCl, KCl, and a combination thereof may be appropriate.

The content of the inorganic salt may range from about 0.1 part by weight to about 10 parts by weight based on 100 parts by weight of the entire active material. When the content of the inorganic salt falls in the above range, it is advantageous in that the battery capacity of the rechargeable lithium battery including the negative active material is not reduced. The content of the inorganic salt may be somewhat different within the range according to the kind of the inorganic salt. For example, when the inorganic salt includes Li as cation, the content of the inorganic salt may range from about 0.1 part by weight to about 2 parts by weight based on 100 parts by weight of the entire active material, and when the inorganic salt includes K as cation, the content may range from about 5 parts by weight to about 10 parts by weight. When the inorganic salt includes Na as cation, the content may range from about 1 part by weight to about 10 parts by weight. The content of the inorganic salt may be controlled by those of an ordinary skill in the art within the range according to the kind, concentration or coating conditions of an inorganic salt coating liquid.

The inorganic salt coating liquid is prepared by dissolving the inorganic salt in a solvent and adding the Si-based material coated with carbon and the inorganic salt coating liquid is applied to the surface of the carbon coating layer. The solvent may be selected from the group consisting of water, alcohol, acetone, tetrahydrofuran, and a combination thereof. The concentration of the inorganic salt may range from about 5 wt % to about 20 wt %. When a solution of the concentration is used, an appropriate coating concentration of an appropriate coating amount may be acquired. When the coating concentration is too low, the coating amount may be too small, and although the coating concentration is high, the coating amount is not increased any more.

Meanwhile, a solution prepared by dissolving the inorganic salt in the solvent may further include a binder. Examples of the binder include polyvinylalcohol, carboxylmethyl cellulose, hydroxypropyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, poly acrylic acid, polyethylene, a polypropylene styrene-butadiene rubber, an acrylated styrene-butadiene rubber, an epoxy resin, nylon, or a combination thereof, but are not limited thereto.

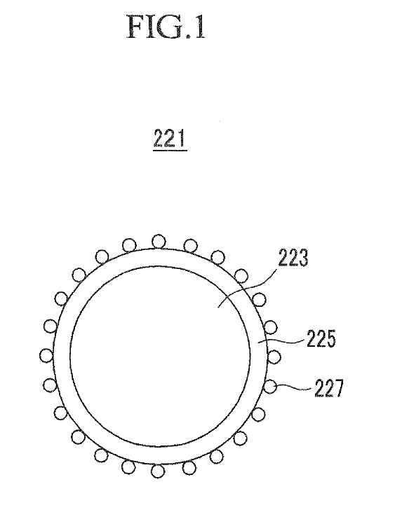

The prepared negative active material may have an average particle diameter of about 1 μm to about 20 μm. FIG. 1 schematically illustrates a structure of the negative active material, but the structure of the negative active material according to one embodiment of this disclosure is not limited to the structure shown in FIG. 1. The negative active material 221 shown in FIG. 1 includes a core 223 formed of a Si-based material and a carbon coating layer 225 formed on the surface of the core formed of the Si-based material. An inorganic salt 227 is disposed on the surface of the carbon coating layer.

The inorganic salt may exist in the form of a layer covering the entire surface of the carbon coating layer or in the form of islands. The aforementioned islands may take the form of spherical particles that uniformly cover the carbon coating layer 225, but not necessarily limited to the aforementioned shape and distribution.

The negative electrode includes a current collector and a negative active material layer formed in the current collector, and the negative active material layer includes the negative active material according to one embodiment of this disclosure, a binder and selectively a conductive material.

The binder makes the particles of the negative active material adhere to each other, and also makes the negative active material adhere to the current collector. Non-limiting examples of the binder include an organic-based binder, an aqueous binder and a combination thereof. The organic-based binder signifies a binder that is dissolved or dispersed in an organic solvent, e.g., N-methylpyrrolidone(NMP), and the aqueous binder means a binder that uses water as a solvent or a dispersion medium.

When the organic-based binder is used as the binder, non-examples of the organic-based binder include polyvinylidene fluoride (PVDF), polyimide, polyamideimide, and a combination thereof but are not limited thereto.

The binder may include an aqueous binder. Examples of the aqueous binder include a rubber-based binder such as a styrene-butadiene rubber, an acrylated styrene-butadiene rubber, an acrylonitrile-butadiene rubber, an acryl rubber, a butyl rubber, a fluorine rubber, and the like, polytetrafluoroethylene, polyethylene, polypropylene, an ethylenepropylene copolymer, polyethyleneoxide, polyvinylpyrrolidone, polyepichlorohydrin, polyphosphazene, polyacrylonitrile, polystyrene, an ethylene propylene diene copolymer, polyvinylpyridine, a chlorosulfonated polyethylene, latex, a polyester resin, an acryl resin, a phenol resin, an epoxy resin, polyvinyl alcohol, or a combination thereof, but are not limited thereto.

When the aqueous binder is used, a thickener may be further included. The thickener is a material that gives viscosity and ion conductivity to the aqueous binder that does not have viscosity. Examples of the thickener include carboxylmethyl cellulose (CMC), hydroxypropylmethyl cellulose and a combination thereof but are not limited thereto.

The thickener may be included in a content ranging from about 0.1 part by weight to about 10 parts by weight based on 100 parts by weight of the binder. When the thickener is included within the range, it is possible to prevent a phenomenon that an electrode plate becomes hard while preventing a sedimentation phenomenon at the same time.

The conductive material is used to give conductivity to an electrode, and any electroconductive materials that do not cause a chemical change may be used. Non-limiting examples of the conductive material include natural graphite, artificial graphite, and a mixture of conductive materials such as polyphenylene derivatives.

The current collector may be selected from the group consisting of a copper foil, a nickel foil, a stainless steel foil, a titanium foil, a nickel foam, a copper foam, a polymer substrate coated with a conductive metal, and combinations thereof.

The positive electrode includes a current collector and a positive active material layer disposed on the current collector. The positive active material includes lithiated intercalation compounds that reversibly intercalate and deintercalate lithium ions. The positive active material may include a composite oxide including at least one selected from the group consisting of cobalt, manganese, and nickel, as well as lithium. In particular, the following lithium-containing compounds may be used:

LiₐA_{1-b}X_{b}D₂(0.90≦a≦1.8, 0≦b≦0.5); LiₐE_{1-b}X_{b}O_{2-c}D_{c} (0.90≦a≦1.8, 0≦b≦0.5, 0≦c≦0.05); LiE_{2-b}X_{b}O_{4-c}D_{c} (0≦b≦0.5, 0≦c≦0.05); LiₐNi_{1-b-c}Co_{b}X_{c}D_{α}(0.90≦a≦1.8, 0≦b≦0.5, 0≦c≦0.05, 0<α≦2); LiₐNi_{1-b-c}Co_{b}X_{c}O_{2-α}T_{α}(0.90≦a≦1.8, 0≦b≦0.5, 0≦c≦0.05, 0<α<2); LiₐNi_{1-b-c}Co_{b}X_{c}O_{2-α}T₂ (0.90≦a≦1.8, 0≦b≦0.5, 0≦c≦0.05, 0<α<2); LiₐNi_{1-b-c}Mn_{b}X_{c}D_{α}(0.90≦a≦1.8, 0≦b≦0.5, 0≦c≦0.05, 0<α≦2); LiₐNi_{1-b-c}Mn_{b}X_{c}O_{2-α}T_{α}(0.90≦a≦1.8, 0≦b≦0.5, 0≦c≦0.05, 0<α<2); LiₐNi_{1-b-c}Mn_{b}X_{c}O_{2-α}T₂ (0.90≦a≦1.8, 0≦b≦0.5, 0≦c≦0.05, 0<α<2); LiₐNi_{b}E_{c}G_{d}O₂ (0.90≦a≦1.8, 0≦b≦0.9, 0≦c≦0.5, 0.001≦d≦0.1); LiₐNi_{b}Co_{c}Mn_{d}GeO₂ (0.90≦a≦1.8, 0≦b≦0.9, 0≦c≦0.5, 0≦d≦0.5, 0.001≦e≦0.1); LiₐNiG_{b}O₂ (0.90≦a≦1.8, 0.001≦b≦0.1); LiₐCoG_{b}O₂ (0.90≦a≦1.8, 0.001≦b≦0.1); LiₐMnG_{b}O₂ (0.90≦a≦1.8, 0.001≦b≦0.1); LiₐMn₂G_{b}O₄ (0.90≦a≦1.8, 0.001≦b≦0.1); QO₂; QS₂; LiQS₂; V₂O₅; LiV₂O₅; LiZO₂; LiNiVO₄; Li_{(3-f)}J₂(PO₄)₃(0≦f≦2); Li_{(3-f)}Fe₂(PO₄)₃(0≦f≦2); LiFePO₄

In the above formulae, A is selected from the group consisting of Ni, Co, Mn, and a combination thereof; X is selected from the group consisting of Al, Ni, Co, Mn, Cr, Fe, Mg, Sr, V, a rare earth element, and a combination thereof; D is selected from the group consisting of O, F, S, P, and a combination thereof; E is selected from the group consisting of Co, Mn, and a combination thereof; T is selected from the group consisting of F, S, P, and a combination thereof; G is selected from the group consisting of Al, Cr, Mn, Fe, Mg, La, Ce, Sr, V, and a combination thereof; Q is selected from the group consisting of Ti, Mo, Mn, and a combination thereof; Z is selected from the group consisting of Cr, V, Fe, Sc, Y, and a combination thereof; and J is selected from the group consisting of V, Cr, Mn, Co, Ni, Cu, and a combination thereof.

The compound may have a coating layer on the surface, or the compound may be used after mixed with another compound having a coating layer thereon. The coating layer may include at least one coating element compound selected from the group consisting of oxide and hydroxide of a coating element, oxyhydroxide of a coating element, oxycarbonate of a coating element, and hydroxycarbonate of a coating element, and a combination thereof. The compound that forms the coating layer may be amorphous or crystalline. The coating element included in the coating layer may be at least one selected from the group consisting of Mg, Al, Co, K, Na, Ca, Si, Ti, V, Sn, Ge, Ga, B, As, Zr, or a mixture thereof. The coating layer can be formed of the aforementioned compounds and elements in any forming method as long as it does not deteriorate the physical properties of the positive active material, such as spray coating, impregnation. Since this method is obvious to those skilled in the art to which this disclosure pertains, it will not be described herein in detail.

The positive active material layer also includes a binder and a conductive material.

The binder improves binding properties of the positive active material particles to one another, and also with a current collector. Examples of the binder include at least one selected from the group consisting of polyvinylalcohol, carboxylmethylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material is included to improve electrode conductivity. Any electrically conductive material may be used as a conductive material unless it causes a chemical change. Examples of the conductive material include one or more of natural graphite, artificial graphite, carbon black, acetylene black, ketjen black, carbon fiber, a metal powder or a metal fiber including copper, nickel, aluminum, or silver, and polyphenylene derivatives.

The current collector may be Al, but is not limited thereto.

The negative and positive electrodes may be fabricated by a method including mixing the active material, a conductive material, and a binder into an active material composition and coating a current collector with the composition. The electrode manufacturing method is well known, and thus is not described in detail in the present specification. The solvent may be N-methylpyrrolidone, water, and the like, but it is not limited thereto.

In a rechargeable lithium battery according to one embodiment, a non-aqueous electrolyte includes a non-aqueous organic solvent and a lithium salt.

The non-aqueous organic solvent serves as a medium for transmitting ions taking part in the electrochemical reaction of the battery.

The non-aqueous organic solvent may include a carbonate-based, ester-based, ether-based, ketone-based, alcohol-based, or aprotic solvent. Examples of the carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and so on. Examples of the ester-based solvent may include methyl acetate, ethyl acetate, n-propyl acetate, dimethylacetate, methylpropionate, ethylpropionate, γ-butyrolactone, decanolide, valerolactone, mevalonolactone, caprolactone, and so on. Examples of the ether-based solvent include dibutyl ether, tetraglyme, diglyme, dimethoxyethane, 2-methyltetrahydrofuran, tetrahydrofuran, and so on, and examples of the ketone-based solvent include cyclohexanone, and so on. Examples of the alcohol-based solvent include ethyl alcohol, isopropyl alcohol, and so on, and examples of the aprotic solvent include nitriles such as R—CN (wherein R is a C2 to C20 linear, branched, or cyclic hydrocarbon, a double bond, an aromatic ring, or an ether bond), amides such as dimethylformamide, dioxolanes such as 1,3-dioxolane, sulfolanes, and so on.

The non-aqueous organic solvent may be used singularly or in a mixture. When the organic solvent is used in a mixture, the mixture ratio can be controlled in accordance with a desirable battery performance.

The carbonate-based solvent may include a mixture of a cyclic carbonate and a linear carbonate. The cyclic carbonate and the chain carbonate are mixed together in the volume ratio of about 1:1 to about 1:9, and when the mixture is used as an electrolyte, the electrolyte performance may be enhanced.

In addition, the non-aqueous organic electrolyte may further include mixtures of carbonate-based solvents and aromatic hydrocarbon-based solvents. The carbonate-based solvents and the aromatic hydrocarbon-based solvents may be mixed together in the volume ratio of about 1:1 to about 30:1.

The aromatic hydrocarbon-based organic solvent may be represented by the following Chemical Formula 1.

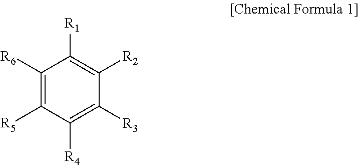

In the above Chemical Formula 1, R₁ to R₆ are independently hydrogen, a halogen, a C1 to C10 alkyl, a C1 to C10 haloalkyl, or a combination thereof.

The aromatic hydrocarbon-based organic solvent may include, but is not limited to, at least one selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, or combinations thereof.

The non-aqueous electrolyte may further include vinylene carbonate or an ethylene carbonate-based compound of the following Chemical Formula 2.

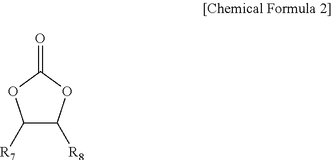

In the above Chemical Formula 2, R₇ and R₈ are independently hydrogen a halogen, a cyano (CN), a nitro (NO₂), and a C1 to C5 fluoroalkyl, a unsaturated aromatic hydrocarbon group, or a unsaturated aliphatic hydrocarbon group, the provided that at least one of R₇ and R₈ is a halogen, a nitro (NO₂), a C1 to C5 fluoroalkyl, a unsaturated aromatic hydrocarbon group, or a unsaturated aliphatic hydrocarbon group, and R₇ and R₈ are not simultaneously hydrogen.

The ethylene carbonate-based compound includes difluoro ethylenecarbonate, chloroethylene carbonate, dichloroethylene carbonate, bromoethylene carbonate, dibromoethylene carbonate, nitroethylene carbonate, cyanoethylene carbonate, fluoroethylene carbonate, and the like. The use amount of the additive for improving cycle life may be adjusted within an appropriate range.

The lithium salt supplies lithium ions in the battery, operates a basic operation of a rechargeable lithium battery, and improves lithium ion transport between positive and negative electrodes. Non-limiting examples of the lithium salt include at least one supporting salt selected from LiPF₆, LiBF₄, LiSbF₆, LiAsF₆, LiN (SO₂C₂F₅)₂, Li (CF₃SO₂)₂N, LiC₄F₉SO₃, LiClO₄, LiAlO₂, LiAlCl₄, LiN (CₓF₂ₓ₊₁SO₂, C_{y}F_{2y+1}SO₂, (where x and y are natural numbers), LiCl, LiI, and LiB(C₂O₄)₂ (lithium bisoxalate borate, LiBOB). The lithium salt may be used in a concentration ranging from about 0.1 M to about 2.0 M. When the lithium salt is included at the above concentration range, electrolyte performance and lithium ion mobility may be enhanced due to optimal electrolyte conductivity and viscosity.

The rechargeable lithium battery may further include a separator between a negative electrode and a positive electrode, as needed. Non-limiting examples of suitable separator materials include polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

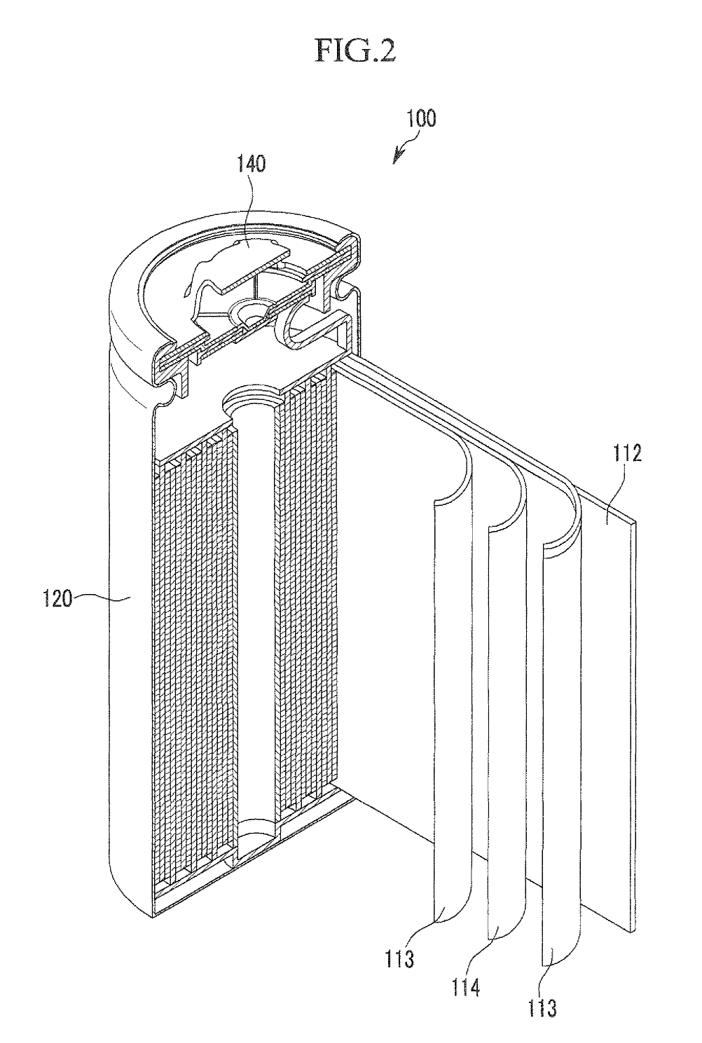

FIG. 2 is a schematic view of a representative structure of a rechargeable lithium battery. FIG. 2 illustrates a cylindrical rechargeable lithium battery 100, which includes a negative electrode 112, a positive electrode 114, a separator 113 interposed between the negative electrode 112 and the positive electrode 114, an electrolyte (not shown) impregnating the separator 113, a battery case 120, and a sealing member 140 sealing the battery case 120. The negative electrode 112, positive electrode 114, and separator 113 are sequentially stacked, spirally wound, and placed in a battery case 120 to fabricate such a rechargeable lithium battery 100.

The following examples illustrate this disclosure in more detail. These examples, however, should not in any sense be interpreted as limiting the scope of this disclosure.

### Example 1

### 1) Fabrication of Negative Electrode

Si particles with a carbon coating layer are acquired by mixing Si particles with petroleum pitch, and performing a heat treatment in the atmosphere of nitrogen (N₂) at about 900° C. for about 6 hours. Through the heat treatment, the petroleum pitch is carbonized and the carbon coating layer including a hard carbon is formed on the surface of the Si particles. The thickness of the carbon coating layer is about 90 nm. A layer-type negative active material is prepared by impregnating the Si particles coated with the carbon in a solution of 10 wt % prepared by dissolving Li₂CO₃, which is an inorganic salt; in water to thereby have the inorganic salt uniformly adhere to the surface of the carbon coating layer. The content of the inorganic salt is about 1 part by weight based on 100 parts by weight of the entire active material. The negative active material has an average particle diameter of about 5 μm. Also, the content of the Si particles of the negative active material is about 94 parts by weight based on 100 parts by weight of the entire active material, and the content of the amorphous carbon is about 5 parts by weight.

A negative active material slurry is prepared by mixing the negative active material, a polyamideimide binder and a carbon black conductive material in a weight ratio of about 8:1:1 in N-methylpyrrolidone solvent. A negative electrode is fabricated through a typical electrode fabrication process in which a Cu-foil current collector is coated with the negative active material slurry.

### 2) Fabrication of Positive Electrode

A positive active material slurry is prepared by mixing LiCoO₂ positive active material, a polyvinylidene fluoride binder and a carbon black conductive material in N-methylpyrrolidone solvent. Herein, the mixing ratio of the positive active material, the binder and the conductive material is about 94:3:3. A positive electrode is fabricated through a typical electrode fabrication process in which an Al-foil current collector is coated with the positive active material slurry.

### 3) Fabrication of Rechargeable Lithium Battery Cell

A rechargeable lithium battery cell is fabricated through a typical process by using the positive electrode, the negative electrode and a non-aqueous electrolyte. As for the non-aqueous electrolyte, a mixed solvent (a volume ratio of about 3:7) of ethylene carbonate and ethylmethylcarbonate where 1.0M of LiPF₆ is dissolved is used.

### Example 2

A rechargeable lithium battery cell is fabricated according to the same method as Example 1 by using Na₂CO₃ as an inorganic salt, instead of Li₂CO₃. The carbon coating layer has a thickness of about 90 nm. The content of the inorganic salt is about 5 parts by weight based on 100 parts by weight of the entire active material. The negative active material has an average particle diameter of about 5 μm.

### Example 3

A rechargeable lithium battery cell is fabricated according to the same method as Example 1 by using K₂CO₃ as an inorganic salt, instead of Li₂CO₃. The carbon coating layer has a thickness of about 90 nm. The content of the inorganic salt is about 5 parts by weight based on 100 parts by weight of the entire active material. The negative active material has an average particle diameter of about 5 μm.

### Example 4

A rechargeable lithium battery cell is fabricated according to the same method as Example 1 by using LiCl as an inorganic salt, instead of Li₂CO₃. The carbon coating layer has a thickness of about 90 nm. The content of the inorganic salt is about 1 part by weight based on 100 parts by weight of the entire active material. The negative active material has an average particle diameter of about 5 μm.

### Example 5

A rechargeable lithium battery cell is fabricated according to the same method as Example 1 by using NaCl as an inorganic salt, instead of Li₂CO₃. The carbon coating layer has a thickness of about 90 nm. The content of the inorganic salt is about 5 parts by weight based on 100 parts by weight of the entire active material. The negative active material has an average particle diameter of about 5 μm.

### Example 6

A rechargeable lithium battery cell is fabricated according to the same method as Example 1 by using KCl as an inorganic salt, instead of Li₂CO₃. The carbon coating layer has a thickness of about 90 nm. The content of the inorganic salt is about 5 parts by weight based on 100 parts by weight of the entire active material. The negative active material has an average particle diameter of about 5 μm.

### Example 7

A rechargeable lithium battery cell is fabricated according to the same method as Example 1 by using LiF as an inorganic salt, instead of Li₂CO₃. The carbon coating layer has a thickness of about 90 nm. The content of the inorganic salt is about 1 part by weight based on 100 parts by weight of the entire active material. The negative active material has an average particle diameter of about 5 μm.

### Example 8

A rechargeable lithium battery cell is fabricated according to the same method as Example 1 by using KF as an inorganic salt, instead of Li₂CO₃. The carbon coating layer has a thickness of about 90 nm. The content of the inorganic salt is about 5 parts by weight based on 100 parts by weight of the entire active material. The negative active material, has an average particle diameter of about 5 μm.

### Example 9

A rechargeable lithium battery cell is fabricated according to the same method as Example 1 by using a mixture of polyacrylic acid and polyvinylalcohol mixed at a mixing ratio of about 50:50 as a binder and using water as a solvent of the binder, a conductive agent, and an active material. The carbon coating layer has a thickness of about 90 nm. The content of the inorganic salt is about 1 part by weight based on 100 parts by weight of the entire active material. The negative active material has an average particle diameter of about 5 μm.

### Comparative Example 1

A rechargeable lithium battery cell is fabricated according to the same method as Example 1 by mixing Si particles with petroleum pitch and using a negative active material prepared by performing a heat treatment in the atmosphere of nitrogen (N₂) at about 900° C. for about 6 hours. The carbon coating layer has a thickness of about 90 nm. The negative active material has an average particle diameter of about 5 μm.

The rechargeable lithium battery cells fabricated according to Examples 1 to 9 and Comparative Example 1 is charged and discharged once with about 0.1 C, and their charge capacity, discharge capacity and initial efficiency are measured. The results are as shown in the following Table 1.

TABLE 1

| | | Charge | Discharge | Initial |
|---|---|---|---|---|
| | | capacity | Capacity | efficiency |
| Example | Inorganic salts | (mAh/g) | (mAh/g) | (%) |
| Comparative | — | 1929.1 | 1351.5 | 70.06 |
| Example 1 | | | | |
| Example 1 | Li₂CO₃ | 1838.5 | 1326.7 | 72.16 |
| | with a | | | |
| | polyvinylidene | | | |
| | fluoride binder | | | |
| Example 2 | Na₂CO₃ | 1939.9 | 1399.5 | 72.14 |
| Example 3 | K₂CO₃ | 1828.8 | 1335.3 | 73.02 |
| Example 4 | LiCl | 1880.7 | 1370.4 | 72.87 |
| Example 5 | NaCl | 1889.7 | 1371.2 | 72.56 |
| Example 6 | KCl | 1879.1 | 1373.9 | 73.11 |
| Example 7 | LiF | 1823.6 | 1319.1 | 72.34 |
| Example 8 | KF | 1855.1 | 1367.9 | 73.74 |
| Example 9 | Li₂CO₃ | 1690.1 | 1310.5 | 77.54 |
| | with a | | | |
| | polyacrylic acid | | | |
| | and polyvinyl- | | | |
| | alcohol binder | | | |

It may be seen in Table 1 that the rechargeable lithium battery cells of Examples 1 to 8 using a negative active material which includes Si particles, the carbon coating layer coating the surface of the Si particles, and the inorganic salt disposed on the surface of the carbon coating layer have remarkably improved initial efficiency, compared to the rechargeable lithium battery cell of Comparative Example 1 using a negative active material not coated with an inorganic layer.

The exothermic heats and exothermic peak temperatures of the negative active materials of the rechargeable lithium battery cells fabricated according to Examples 1 to 9 and Comparative Example 1 which are obtained by disassembling electrode plates in a charged state are measured by using a differential scanning calorimetry (DSC), and a DSC ascending temperature curve is drawn by ascending the temperature from about 50° C. to about 400° C. in the atmosphere of nitrogen gas (30 ml/min) at a temperature ascending rate of about 10° C./min. The results are as shown in Table 2.

The differential scanning calorimetry (DSC) is Q2000 differential scanning calorimetry produced by TA Instrument company. The measurement instrument is pressure cell with gold seal sealing.

TABLE 2

| | | Exothermic peak | |
|---|---|---|---|
| | | temperature | Exothermic |
| Example | Inorganic salt | (° C.) | heat (%) |
| Comparative | — | 342 | 100 |
| Example 1 | | | |
| Example 1 | Li₂CO₃ | 353 | 10 |
| | with a | | |
| | polyvinylidene | | |
| | fluoride binder | | |
| Example 2 | Na₂CO₃ | 373 | 60 |
| Example 3 | K₂CO₃ | — | 0 |
| Example 4 | LiCl | 350 | 15 |
| Example 5 | NaCl | 389 | 70 |
| Example 6 | KCl | 360 | 5 |
| Example 7 | LiF | 354 | 10 |
| Example 8 | KF | — | 0 |
| Example 9 | Li₂CO₃ | 357 | 20 |
| | with a | | |
| | polyacrylic acid | | |
| | and polyvinyl- | | |
| | alcohol binder | | |

Referring to Table 2, the negative active materials acquired from the rechargeable lithium battery cells fabricated according to Examples 1 to 9 are stable at higher temperature than rechargeable lithium battery cells fabricated using a negative active material prepared according to Comparative Example 1.

Referring to Table 2, the negative active materials acquired from the rechargeable lithium battery cells fabricated according to Examples 1 to 9 have an exothermic peak temperature of higher than about 350° C. Particularly, when Na₂CO₃, K₂CO₃, NaCl, KCl or KF is used as an inorganic salt, the exothermic peak temperature is higher than about 360° C. or goes beyond measurement, which signifies thermal stability at a high temperature. The rechargeable lithium battery cells fabricated according to Example 3 (K₂CO₃) and Example 8 (KF) whose exothermic peak temperature is not measured turn out to have excellent thermal stability.

Also, the exothermic heats of Table 2 are relative values determined when it is assumed that the exothermic heat of Comparative Example 1 is 100. It may be seen from Table 2 that the exothermic heats of Examples 1 to 9 are significantly reduced, compared to that of the Comparative Example 1. In particular, the rechargeable lithium battery cells of Example 3 (K₂CO₃) and Example 8 (KF), the relative exothermic heat with respect to that of Comparative Example 1 is 0, which signifies excellent thermal stability.

The capacity retentions (i.e., cycle life characteristics) of the rechargeable lithium battery cells fabricated according to Examples 1 to 9 and Comparative Example 1 are measured and the results are as shown in the following Table 3. The capacity retentions (i.e., cycle life characteristics) are measured by performing a charge and discharge at about 25° C. with about 1.0 C for about 50 times. The measurement result is shown as a ratio of a discharge capacity at the 50^{th} cycle to a discharge capacity at the first cycle.

The impedances of the rechargeable lithium battery cells fabricated according to Examples 5 and 6 and Comparative Example 1 are measured with a potentiostat produced by Solartron company. The impedance is measured in the rage of about 100,000 Hz to about 0.01 Hz with an alternating current (AC) voltage of about 5 mV, and the rechargeable lithium battery cell is in an OCV state after the initial charge when the impedance is measured.

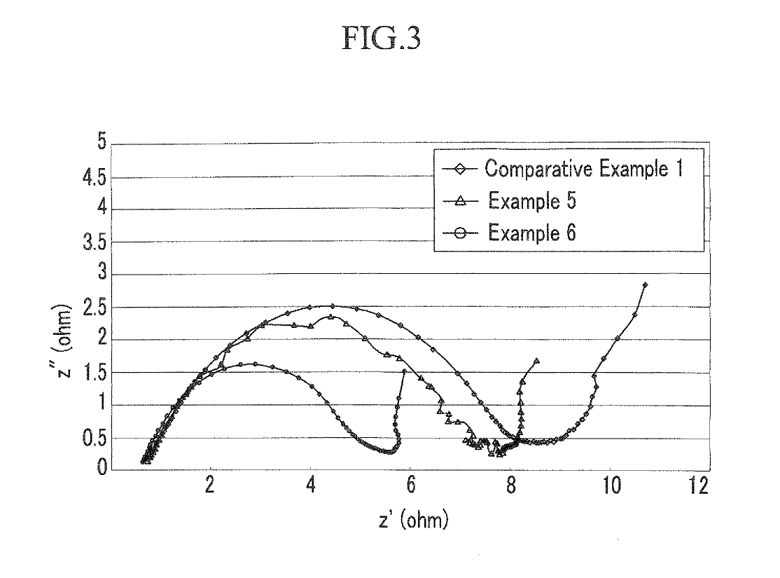

FIG. 3 is a graph comparing the resistances of the rechargeable lithium battery cell fabricated according to Comparative Example 1 including a carbon coating layer not coated with an inorganic salt, the rechargeable lithium battery cell fabricated according to Example 5 using NaCl as an inorganic salt, and the rechargeable lithium battery cell fabricated according to Example 6 using KCl as an inorganic salt based on electrochemical impedance spectrometry (EIS). Referring to FIG. 3, the rechargeable lithium battery cell including a negative active material including Si-based particles coated with carbon and an inorganic salt has a substantially reduced resistance.

TABLE 3

| | | Capacity retention |
|---|---|---|
| | Inorganic salt | at 50 cycle (%) |
| Comparative | — | 75 |
| Example 1 | | |
| Example 1 | Li₂CO₃ | 80 |
| | with a | |
| | polyvinylidene | |
| | fluoride binder | |
| Example 2 | Na₂CO₃ | 77 |
| Example 3 | K₂CO₃ | 78 |
| Example 4 | LiCl | 77 |
| Example 5 | NaCl | 77 |
| Example 6 | KCl | 79 |
| Example 7 | LiF | 83 |
| Example 8 | KF | 85 |
| Example 9 | Li₂CO₃ | 70 |
| | with a | |
| | polyacrylic acid | |
| | and polyvinyl- | |
| | alcohol binder | |

Referring to Table 3, the capacity retention of the rechargeable lithium battery cell fabricated according to Examples 1 to 8 at the 50th cycle is higher than the capacity retention of the rechargeable lithium battery cell, fabricated according to Comparative Example 1 at the 50th cycle. Therefore, it may be seen that the rechargeable lithium battery cells including the negative active material prepared according to one embodiment of this disclosure have improved cycle life characteristic.

While this disclosure has been described in connection with what is presently considered to be practical exemplary embodiments, it is to be understood that this disclosure is not limited to the disclosed embodiments, but, on the contrary, is intended to cover various modifications and equivalent arrangements included within the spirit and scope of the appended claims.

What is claimed is:

1. A negative active material for a rechargeable lithium battery, comprising
a Si-based material core;
a carbon coating layer coating a surface of the Si-based material core; and
an inorganic salt positioned on a surface of the carbon coating layer.

2. The negative active material of claim 1, wherein the Si-based material core comprises Si, SiOₓ (0<x<2), a Si—Z alloy (where Z is an element selected from the group consisting of an alkali metal, an alkaline-earth metal, a group 13 element, a group 14 element, a transition element, a rare earth element, and a combination thereof, and not Si), or a combination thereof.

3. The negative active material of claim 1, wherein the carbon coating layer includes an amorphous carbon.

4. The negative active material of claim 1, wherein the carbon coating layer is an amorphous carbon selected from the group consisting of soft carbon, hard carbon, mesophase pitch carbide, fired coke and a mixture thereof.

5. The negative active material of claim 1, wherein the carbon coating layer is included in a content ranging from about 1 part by weight to about 20 parts by weight based on 100 parts by weight of the entire active material.

6. The negative active material of claim 1, wherein the carbon coating layer has a thickness ranging from about 1 nm to about 100 nm.

7. The negative active material of claim 1, wherein the inorganic salt is selected from the group consisting of a salt of alkali metal cation and carbonate anion, a salt of alkali cation and halogen anion, and a combination thereof.

8. The negative active material of claim 1, wherein the inorganic salt is selected from the group consisting of Li₂CO₃, Na₂CO₃, K₂CO₃, LiF, KF, LiCl, NaCl, KCl and a combination thereof.

9. The negative active material of claim 1, wherein the inorganic salt is selected from the group consisting of Na₂CO₃, K₂CO₃, KF, NaCl, KCl and a combination thereof.

10. The negative active material of claim 1, wherein the inorganic salt is included in a content ranging from about 0.1 part by weight to about 10 parts by weight based on 100 parts by weight of the entire active material.

11. The negative active material of claim 1, wherein the inorganic salt exists in a form of a layer covering the entire surface of the carbon coating layer or in a form of islands covering at least a portion of the surface of the carbon coating layer.

12. The negative active material of claim 1, wherein the negative active material has an average particle diameter ranging from about 1 μm to about 20 μm.

13. A rechargeable lithium battery, comprising:
a negative electrode including a negative active material comprising
a Si-based material core;
a carbon coating layer coating a surface of the Si-based material core; and
an inorganic salt positioned on a surface of the carbon coating layer;
a positive electrode including a positive active material; and
a non-aqueous electrolyte.

14. The rechargeable lithium battery of claim 13, wherein the inorganic salt is selected from the group consisting of a salt of alkali metal cation and carbonate anion, a salt of alkali cation and halogen anion, and a combination thereof.

15. The rechargeable lithium battery of claim 13, wherein the inorganic salt is selected from the group consisting of Li₂CO₃, Na₂CO₃, K₂CO₃, LiF, KF, LiCl, NaCl, KCl and a combination thereof.

16. The rechargeable lithium battery of claim 13, wherein the inorganic salt is selected from the group consisting of Na₂CO₃, K₂CO₃, KF, NaCl, KCl and a combination thereof.

17. The rechargeable lithium battery of claim 13, wherein the inorganic salt is included in a content ranging from about 0.1 part by weight to about 10 parts by weight based on 100 parts by weight of the entire active material.

18. A rechargeable lithium battery, comprising:
a negative electrode including a negative active material comprising
a Si-based material core;
a carbon coating layer coating a surface of the Si-based material core; and
an inorganic salt, in the form of particles, at partially covering and uniformly distributed over a surface of the carbon coating layer;
a positive electrode including a positive active material; and
a non-aqueous electrolyte,
wherein the inorganic salt is selected from the group consisting of Li₂CO₃, Na₂CO₃, K₂CO₃, LiF, KF, LiCl, NaCl, KCl and a combination thereof.

19. The rechargeable lithium battery of claim 18, wherein the inorganic salt completely and entirely covers the carbon coating layer.

20. The rechargeable lithium battery of claim 18, wherein the inorganic salt is included in a content ranging from about 0.1 part by weight to about 10 parts by weight based on 100 parts by weight of the entire active material.
